(19) United States
(12) Patent Application Publication
(10) Pub. No.: US 2026/0264026 A1
(43) Pub. Date: Sep. 10, 2026

(54) METHOD AND USE OF A GRAPHENE OXIDE MEMBRANE FOR REMOVING AT LEAST A PORTION OF ONE OR MORE DISINFECTANTS FROM A LIQUID FEED

(71) Applicants: VANTIVE US HEALTHCARE LLC, Deerfield, IL (US); NEWSOUTH INNOVATIONS PTY LIMITED, Sydney (AU)

(72) Inventors: Tobias FOLLER, Maroubra, New South Wales (AU); Xinyue WEN, Kingsford, New South Wales (AU); Cristina SCRET, Dalby (SE); Matthew R. MULLER, Lindenhurst, IL (US); Rakesh JOSHI, Kensington, New South Wales (AU)

(21) Appl. No.: 19/491,276

(22) PCT Filed: Jun. 5, 2024
(86) PCT No.: PCT/US2024/032551

§ 371 Date: Dec. 8, 2025

(30) Foreign Application Priority Data
Jun. 7, 2023 (AU) 2023901802

(51) Int. Cl. B01D 71/02; B01D 69/02; B01D 69/08; B01D 69/10; B01D 69/14; C02F 1/28; C02F 1/44; C02F 101/12

(52) U.S. Cl. CPC B01D 71/0211; B01D 69/02; B01D 69/08; B01D 69/107; B01D 69/147; C02F 1/283; C02F 1/44; B01D 2325/04; C02F 2101/12; C02F 2303/185

(57) ABSTRACT

The present invention relates to a method and use of a graphene oxide membrane for removing at least a portion of one or more disinfectants from a liquid feed, wherein the disinfectants are solutes selected from the group consisting of chlorine and/or a chloramine.

### FIELD OF THE INVENTION

The present invention relates to a method and use of a graphene oxide membrane for removing at least a portion of one or more disinfectants from a liquid feed. Whilst the invention has been developed for water purification purposes, it will be appreciated that the invention is not limited to this particular field of use.

### BACKGROUND OF THE INVENTION

The following discussion of the prior art is provided to place the invention in an appropriate technical context and enable the advantages of it to be more fully understood. It should be appreciated, however, that any discussion of the prior art throughout the specification should not be considered as an express or implied admission that such prior art is widely known or forms part of the common general knowledge in the field.

Chlorine, or more specifically chlorine dioxide or hypochlorite (ClO⁻), and the family of chloramines (monochloramine (NH₂Cl), dichloramine (NHCl₂) and trichloramine (NCl₃)) play a vital role as disinfectants in water treatment plants and municipal water supplies in countries around the world. These disinfectants are used to prevent the build-up of bacteria in water and thus enable the production of safe tap water for drinking. While certain concentrations of these disinfectants are acceptable for drinking water, it restricts the usage of tap water for applications with lower chlorine tolerance such as certain medical devices, food processing industry and aquaculture activities.

In addition, the presence of residual chlorine and chloramines in desalination plants poses a problem in reverse osmosis (RO) membranes, nanofiltration (NF) membranes and ion-exchange (IEX) membranes. As such polymeric membranes have a low tolerance (<0.1 ppm) towards these disinfectants. However, biofouling is often a problem in RO applications and these disinfectants are commonly used to pre-treat the water to prevent such biofouling. As the RO membranes are sensitive to chlorine and chloramines, any residual chlorine and/or chloramines need to be removed before the water encounters the RO membrane.

Currently, activated carbon (AC) filters are typically used to remove residual chlorine and chloramines from water systems. While this is in principle, practical and economically viable, the use of AC filters has some unwanted side effects and drawbacks. Indeed, the AC filters used in Point of Use (PoU) applications may induce the production of undesired bacteria in the effluent of the filter due to the build-up of a biofilm inside the AC block. Moreover, the AC filters may fail which could be critical, especially in medical devices. Developing a technology that can remove any residual chlorine and/or chloramines to a concentration below 0.1 ppm and overcome these challenges associated with AC filters, such as the build-up of a biofilm, is thus very desirable.

Graphene oxide (GO) membranes are an upcoming candidate for next-generation filtration membranes. GO membranes have good chemical and antibacterial properties and good resistance towards certain disinfectants, including chlorine.

It is widely accepted that the successful filtration of species from a liquid feed or medium through commercially available GO membranes will be largely dictated by the size of the pores or channels defined by the interlayer spacing between stacked GO sheets of the GO membrane; in other words, the molecular cut-off. The molecular cut-off for commercially available GO membranes is reported in the literature to be in the range of around 4.6 Å to 4.7 Å. This means that species with a hydrated radius larger than the size of the pores or channels of GO membranes will be rejected (blocked) by the membrane. While species with a hydrated radius that is smaller than 4.6 Å will be expected to pass straight though the GO membrane, rather than rejected (filtered).

The hydrated radii for hypochlorite, ClO (~3.5 Å) and monochloramine (NH₂Cl) (4.5 Å) disinfectants are both below the molecular cut-off (~4.6-4.7 Å) of untreated GO membranes. Given this, one would expect that neither ClO— nor NH₂Cl would be rejected (filtered) by an untreated GO membrane.

The present invention seeks to provide a method and use of a graphene oxide membrane for removing at least a portion of one or more disinfectants from a liquid feed, which will overcome or substantially ameliorate at least some of the deficiencies of the prior art, or to at least provide an alternative.

### SUMMARY OF THE INVENTION

According to a first aspect, the present invention provides a graphene oxide membrane for removing at least a portion of one or more disinfectants from a liquid feed, wherein the disinfectants are solutes selected from the group consisting of chlorine and/or a chloramine.

Surprisingly, the inventors have observed that graphene oxide (GO) membranes with the structural characteristics as defined in more detail below, can be used to remove residual chlorine and/or chloramine disinfectants from a liquid feed to levels of around 0.04 ppm or less. This has several commercial advantages over the commercially available GO membranes, particularly from the standpoint of filtering water for use in medical, food processing or aquaculture applications, where the presence of residual chlorine and/or chloramine disinfectants can be detrimental.

The inventors firmly believe that the GO membranes of the present invention will also find useful application in desalination plants that conventionally use reverse osmosis (RO) membranes, which typically have a low tolerance to the residual chlorine and/or chloramine disinfectants used to minimize undesirable growth of microbes on these RO membranes.

Suitably, the graphene oxide membrane comprises one or more layers of graphene oxide flakes supported on at least one surface of a substrate.

In a preferred embodiment, the graphene oxide membrane comprises two or more layers of graphene oxide flakes supported on at least one surface of the substrate, wherein an interlayer spacing between the two or more layers of graphene oxide flakes was determined to fall within a range of between about 0.4 nm to about 5 nm.

It will be appreciated by persons skilled in the relevant art that the lower end of this broad range of interlayer spacing (also referred to as “pore size”) is only achievable under certain conditions, and particularly under conditions where the level of water is kept to an absolute minimum to avoid swelling.

In one form, the substrate is a porous membrane (i.e., a flat sheet membrane).

Preferably, the one or more layers of graphene oxide flakes supported on the at least one surface of the porous membrane defines an active area that falls within a range of between about 1 cm² to about 40 m².

Preferably, the one or more layers of graphene oxide flakes supported on the at least one surface of the porous membrane has a thickness that falls within a range of between about 10 nm to about 10 μm.

Preferably, the graphene oxide membrane has a mass loading of graphene oxide flakes on the at least one surface of the porous membrane that falls within a range of between about 0.01 mg/cm² to about 1 mg/cm².

In another form, the substrate comprises one or more hollow fibres (i.e., a hollow fibre membrane).

In one embodiment, the one or more hollow fibres are porous.

Preferably, the or each hollow fibre has a length that falls within a range of between about 1 cm to about 5 m.

Preferably, the one or more layers of graphene oxide flakes supported on at least one surface of the or each hollow fibre have a thickness that falls within a range of between about 10 nm to about 10 μm.

Preferably, the one or more layers of graphene oxide flakes supported on the at least one surface of the or each hollow fibre define an active area that falls within a range of between about 1 cm² to about 20 m².

Preferably, the graphene oxide membrane has a mass loading of graphene oxide flakes on the at least one surface of the or each hollow fibre that falls within a range of between about 0.01 mg/cm² to about 1 mg/cm².

In one embodiment, the GO membrane is treated at a temperature that falls within a range of between about 25° C. to about 100° C.

In one embodiment, the GO membrane is treated at a pressure that falls within a range of between about 0.1 bar to about 10 bar.

Preferably, the substrate is manufactured from a polymer selected from the group consisting of polyvinylidene fluoride (PVDF), cellulose acetate (CA), polysulfone (PS), polyamide, polyacrylonitrile (PAN) and polyether sulfone (PES), a ceramic selected from the group consisting of aluminium oxide (Al₂O₃), or any combination thereof.

In one embodiment, the liquid feed is an aqueous medium selected from the group consisting of tap water, wastewater and municipal water supply.

In one embodiment, the chloramine is selected from the group consisting of monochloramine (NH₂Cl), dichloramine (NHCl₂), trichloramine (NCl₃), or any combination thereof.

According to a second aspect, the present invention provides a method of removing at least a portion of one or more disinfectants from a liquid feed, comprising:
passing a liquid feed comprising one or more disinfectants over and/or through a graphene oxide membrane, thereby removing at least a portion of the one or more residual disinfectants from the liquid feed,
wherein the disinfectants are solutes selected from the group consisting of chlorine and/or a chloramine.

In one embodiment, the chloramine is selected from the group consisting of monochloramine (NH₂Cl), dichloramine (NHCl₂), trichloramine (NCIs), or any combination thereof.

When chloramines are used to disinfect drinking water, monochloramine is the most common form and was chosen as a marker for our testing. Chloramines are frequently produced by adding ammonia to water containing free chlorine.

The above three species of inorganic chloramines can be formed based on pH value and the amounts of chlorine and ammonia used. For instance, monochloramine is obtained in solution at pH>7, dichloramine is obtained at pH 4-7, and trichloramine is obtained at pH 1-3.

Organic chloramines (more accurately referred to as organic N-chloramines) can also be formed when free chlorine reacts with organic nitrogen compounds present in drinking water. Since little information is available on the formation or occurrence of organic chloramines in drinking water, the testing outlined in the detailed description below focuses solely on the removal of inorganic chloramines, with specifically monochloramine as a marker for the testing.

In one embodiment, the graphene oxide membrane comprises one or more layers of graphene oxide flakes supported on at least one surface of a porous substrate, wherein the liquid feed comprises chlorine, and wherein the liquid feed passes through the graphene oxide membrane at a water flux that falls within a range of between about 0.1 L m⁻² h⁻¹ bar⁻¹ to about 200 L m⁻² h⁻¹ bar⁻¹.

In one embodiment, the graphene oxide membrane comprises one or more layers of graphene oxide flakes supported on at least one surface of a porous substrate, wherein the liquid feed comprises a chloramine, and wherein the liquid feed passes through the graphene oxide membrane at a water flux that falls within a range of between about 0.1 L m⁻² h⁻¹ bar⁻¹ to about 200 L m⁻² h⁻¹ bar⁻¹.

In one embodiment, the graphene oxide membrane comprises one or more layers of graphene oxide flakes supported on at least one surface of each of a plurality of hollow fibres, wherein the liquid feed comprises chlorine, and wherein the liquid feed passes over and/or through the graphene oxide membrane at a water flux that falls within a range of between about 1.1 L m⁻² h⁻¹ bar⁻¹ to about 0.85 L m⁻² h⁻¹ bar⁻¹.

In one embodiment, the graphene oxide membrane comprises one or more layers of graphene oxide flakes supported on at least one surface of each of a plurality of hollow fibres, wherein the liquid feed comprises a chloramine, and wherein the liquid feed passes over and/or through the graphene oxide membrane at a water flux that falls within a range of between about 3.0 L m⁻² h⁻¹ bar⁻¹ to about 2.6 L m⁻² h⁻¹ bar⁻¹.

In a preferred embodiment, the concentration of chloramine in the permeate is less than 0.1 ppm, preferably less than 0.04 ppm.

In one embodiment, the liquid feed is passed over and/or through the graphene oxide membrane at standard temperature and pressure.

In one embodiment, the liquid feed is passed over and/or through the graphene oxide membrane at a pressure that falls within a range of between about 0.1 bar to about 5 bar.

In one embodiment, the liquid feed is passed over and/or through the graphene oxide membrane at a temperature that falls within a range of between about 4° C. to about 60° C.

Other aspects of the invention are also disclosed in the following.

### BRIEF DESCRIPTION OF THE DRAWINGS

Notwithstanding any other forms which may fall within the scope of the present invention, preferred embodiments of the invention will now be described, by way of example only, with reference to the accompanying drawings in which:

FIG. 1 shows a schematic representation of a system for: (a) producing flat sheet graphene oxide (GO) membranes by passing a graphene oxide (GO) solution through a flat sheet PVDF membrane mounted on a porous steel substrate within in a dead-end cell, and (b) drying the as-produced flat sheet GO membrane under pressurized condition (2 bar), then testing the as-produced flat sheet GO membrane by (c) gradually loading a feed solution of a test species in water into the dead-end cell, and then (d) filtering the feed solution through the flat sheet GO membrane via pressure-driven dead-end filtration at 1 bar pressure, and then monitoring for the concentration (by mass loading (mg/cm²) of the test species (if any) in the permeate solution collected in a sealed vessel using a set of scales electronically connected to a personal computer (PC);

FIG. 2 shows: (a) a plot of water flux (L m⁻² h⁻¹ bar⁻¹ (LMH/bar) versus mass loading (mg/cm²) of GO flakes used in the fabrication of a series of flat sheet GO membranes produced using the system shown in FIG. 1; and (b) a photograph showing an example of the feed and permeate solution taken from the system shown in FIG. 1(d) after filtering a feed solution comprising chlorine (Cl) through the as-produced flat sheet GO membrane. The feed and permeate solutions are tested for residual Cl using a chemical reagent (N,N diethyl-p-phenylene diamine), where a pink coloration indicates the presence of chlorine (Cl), as confirmed by the use of a HACH DR 900 Multiparameter Portable Colorimeter;

FIG. 3 shows: (a) a plot of chlorine (Cl) concentration (mg/ml) versus time (h) for a study monitoring any change in Cl concentration in a stirred chlorinated solution (in a sealed vessel) measured with (squares) and without (circles) the presence of a flat sheet GO membrane produced using the system shown in FIG. 1; (b) XPS spectra of the C1s peak of flat sheet GO membranes, before and after filtration. (c) SEM image of a microcrack formed in a thin flat sheet GO membrane during prolonged filtration [Scale is 30 μm];

FIG. 4 shows a plot of water flux (ml/min) versus mass loading of GO (mg/cm²) for a flat sheet GO membrane of thickness <0.06 mg/cm², subjected to an aqueous solution comprising hypochlorite (ClO⁻) ions, and the corresponding rejection rate (%) of the ClO⁻ ions by the flat sheet GO membrane, when measured over a period of 24 h;

FIG. 5 shows a schematic representation of: (a) a custom-made system for (i) coating hollow-fibre PVDF membranes with GO flakes to produce hollow-fibre GO membranes according to an embodiment of the present invention, and (ii) removing chlorine and/or chloramine disinfectants from a liquid feed; (b) a photograph of a hollow fibre PVDF membrane coated with GO flakes using the system in FIG. 5(a), and (c) an SEM image of a cross section of a hollow fibre PVDF membrane coated externally with a layer of GO flakes [Scale is 30 μm]; and

FIG. 6 shows plots of concentration (ppm) versus time (days) for test results obtained following the removal of (a) chlorine (Cl) and (b) monochloramine (NH₂Cl) from tap water using hollow fibre GO membranes produced using the system in FIG. 5(a). Over the course of 11 days of continuous operation, the water flux (L m⁻² h⁻¹ bar⁻¹ (LMH/bar) and Cl levels (ppm) in the feed and permeate solutions were monitored.

### DESCRIPTION OF PREFERRED EMBODIMENTS OF THE INVENTION

It should be noted in the following description that like or the same reference numerals in different embodiments denote the same or similar features.

The present invention is predicated on a simple yet robust technology for reducing the concentration of any residual chlorine and/or chloramine disinfectants in wastewater or in a water supply to a safe level, not only for drinking, but also for certain applications, such as medical applications, where the presence of such disinfectants could be detrimental to the application.

Here, the inventors have surprisingly found that graphene oxide (GO) membranes produced according to the present invention can reliably remove residual disinfectants in the form of solutes of chlorine and/or chloramine from a water supply to levels of less than 0.04 ppm. Both flat sheet GO membranes in dead-end configuration and hollow fibre GO membranes in crossflow conditions were tested for their functionality over a series of days. The chemical and structural analyses of these two GO membrane types described in detail below suggest that the GO membranes undergo no detectable chemical changes during the filtration process. Moreover, the obtained results imply that the removal of chlorine (or hypochlorite, ClO⁻) and chloramines such as monochloramine (NH₂Cl), dichloramine (NHCl₂), trichloramine (NCl₃), or any combination thereof, is not based on adsorption or chemical reaction but rather on the filtration properties of the two GO membrane types.

What follows is a detailed description of the fabrication and testing of graphene oxide (GO) membranes formed by depositing GO flakes on the surface of either a porous flat sheet membrane or the surface of each of a plurality of hollow fibres.

### Results and Discussion

### Flat Sheet Membranes

### Fabrication

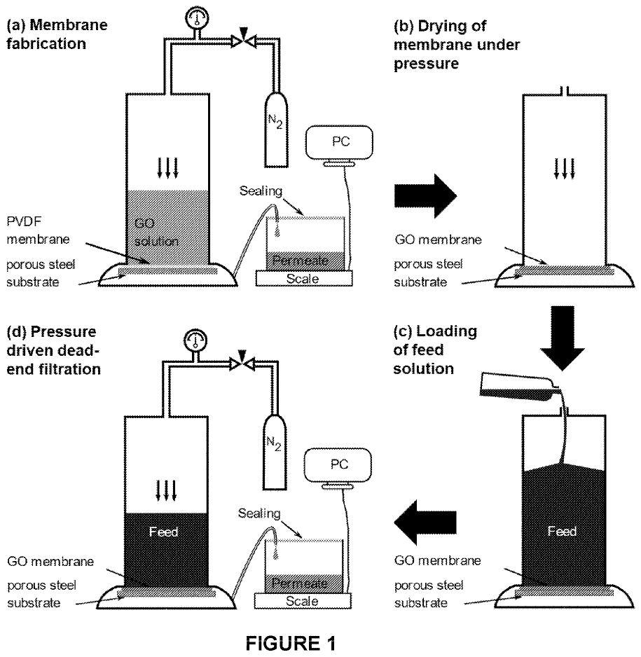

As outlined in the experimental section below, flat sheet graphene oxide membranes employed in the present study have been fabricated by vacuum filtration using the system shown schematically in FIG. 1.

Specifically, as shown in FIG. 1a, a commercially available solution comprising a dispersion of graphene oxide (GO) flakes of known concentration is loaded into a dead-end filtration cell, fitted with a porous steel substrate and a porous polymeric or ceramic substrate mounted on the porous steel substrate to trap layers of the GO flakes on the surface of the porous polymeric or ceramic substrate to form a flat sheet GO membrane. The remaining solution passes through the porous polymeric or ceramic substrate, where it is then collected as a permeate solution in a sealed vessel positioned on a set of scales electronically connected to a personal computer (PC), and analysed to determine the concentration of test species (if any) still remaining in solution, as a means by which to calculate the mass loading (mg/cm²) of GO flakes on the surface of the porous polymeric or ceramic substrate.

The porous substrate can be manufactured from a polymer selected from the group consisting of polyvinylidene fluoride (PVDF), cellulose acetate (CA), polysulfone (PS), polyamide, polyacrylonitrile (PAN) and polyether sulfone (PES), a ceramic selected from the group consisting of aluminium oxide (Al₂O₃), or any combination thereof.

In a preferred embodiment, the porous substrate is a polyvinylidene fluoride (PVDF) membrane with a 0.22 μm pore size.

The GO solution is subsequently filtered through the PVDF membrane under pressure (2 bar) causing the GO flakes from the solution to be deposited on the surface of the PVDF membrane in the form of a uniform layer of GO flakes, while the residual solution passes through the pores of the PVDF membrane and is collected as a permeate.

The one or more layers of GO flakes deposited on the upper surface of the PVDF membrane are then dried under pressure (2 bar) for around 24 h to produce a flat sheet GO membrane, as shown in FIG. 1b.

The resultant flat sheet GO membrane is formed from a mass loading of GO flakes of between about 0.01 mg/cm² to about 1 mg/cm², culminating in a thickness after drying that falls within the range of between about 10 nm to about 10 μm, and an active area that falls within a range of between about 1 cm² to about 40 m².

The mass loading was calculated using Equation (1) considering the effective area of the PVDF substrate coated with GO flakes.

$$GO mass loading = \frac{Mass of GO flakes added}{Effective area of PVDF substrate} \qquad ( 1 )$$

For removing residual chlorine and/or chloramine disinfectants from a particular feed (such as tap water, wastewater or a municipal water supply), the inventors have observed excellent results (as detailed below) in which the flat sheet GO membranes comprise two or more layers of GO flakes formed as stacked sheets supported on the upper surface of the PVDF membrane.

In these flat sheet GO membranes, the interlayer spacing between the stacked layers of graphene oxide flakes, as determined by X-ray diffraction, was observed to fall within a range of between about 1.0 nm to about 1.4 nm.

Additionally, the inventors have observed that the interlayer spacing between stacked GO sheets of the flat sheet GO membrane can be influenced during production by altering the pressure and/or temperature.

For instance, in one embodiment, the flat sheet GO membrane is treated at a temperature that falls within a range of between about 25° C. to about 100° C.

In one embodiment, the flat sheet GO membrane is heat treated at a pressure that falls within a range of between about 0.1 bar to about 10 bar.

As will be discussed in more detail below, good results were obtained when the manufacturing process is conducted at 22° C. and 1 bar to obtain a PVDF membrane comprising a GO coating with a thickness of 500 nm, corresponding to a mass loading of GO flakes of 0.06 mg/cm², in which the GO coating consists of stacked GO sheets having an interlayer spacing of 1.4 nm.

### Testing

As shown in FIG. 1c, the flat sheet GO membranes produced using the system in FIG. 1a were tested for their ability to reject (filter) a test species from solution by loading a feed solution comprising the test species in water into the dead-end cell.

As shown in FIG. 1d, the feed solution comprising the test species is passed through the flat sheet GO membrane via pressure-driven dead-end filtration in order to filter the test species from solution.

In one embodiment, the filtration of the feed solution through the flat sheet GO membrane is conducted at a pressure that falls within a range of between about 0.1 bar to about 5 bar.

In one embodiment, the filtration of the feed solution through the flat sheet GO membrane is conducted at a temperature that falls within a range of between about 4° C. to about 60° C.

In a preferred embodiment, good results were observed, when the filtration is conducted at a pressure of 1 bar at room temperature.

The permeate having passed straight through the flat sheet GO membrane is subsequently collected in a sealed vessel mounted on a set of scales. After filtration, the permeate solution is then analysed using a HACH DR900 Multiparameter Portable Colorimeter (detection limit: 0.04 ppm) to determine the concentration of test species (if any) remaining in solution. The determined concentration can then be compared with the known concentration of the feed solution to calculate the amount of test species that has been rejected (filtered) by the flat sheet GO membrane.

The water flux (L m⁻² h⁻¹ bar⁻¹ (LMH/bar) of the flat sheet GO membranes was calculated from the volume of permeate (as determined using the set of scales), the effective/active area (m²) of the flat sheet GO membrane, the pressure applied during the filtration (1 bar), and the duration (h) of the filtration.

When the liquid feed comprises chlorinated water, the water flux through the flat sheet GO membrane typically falls within a range of between about 0.1 L m 2 h⁻¹ bar⁻¹ to about 200 L m⁻² h⁻¹ bar⁻¹.

Similarly, when the liquid feed comprises a chloramine, the water flux through the flat sheet GO membrane typically falls within a range of between about 0.1 L m⁻² h⁻¹ bar⁻¹ to about 200 L m⁻² h⁻¹ bar⁻¹.

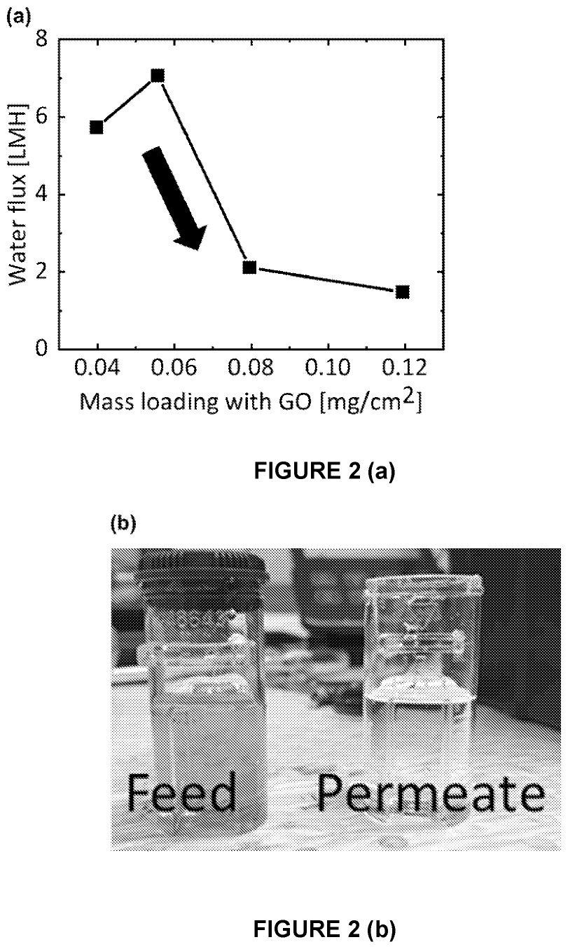

As shown in FIG. 2a, the water flux associated with the flat sheet GO membranes was observed to decrease as the thickness of the stacked layers of GO sheets formed on the upper surface of the PVDF substrate increased. For instance, thin flat sheet GO membranes (mass loading <0.06 mg/cm²) were found to have a relatively high water flux (around 6 to 8 LMH/bar), whereas thicker flat sheet GO membranes (mass loading >0.08 mg/cm²) had a much lower water flux (around 2 LMH/bar).

The as-produced flat sheet GO membranes were investigated against a series of test solutions of tap water and deionized (DI) water comprising certain concentrations of hypochlorite (ClO⁻) and monochloramine (NH₂Cl), as indicated in Table 1, to determine the ability of these GO membranes to reject (filter) NH₂Cl and ClO⁻ from solution.

TABLE 1

| | Concentration of species in test solution (ppm) | |
|---|---|---|
| Test Solution | Monochloramine (NH₂Cl) | Hypochlorite (ClO⁻) |
| Tap water | 2.6 & 4 | 3, 4, 9 & 50 |
| Deionized (DI) -water | 1.6, 3.6 & 5 | 4 & 9 |

For all solutions, the various flat sheet GO membranes tested were found to reduce the total residual ClO⁻ and/or NH₂Cl levels in the permeate to below the detection limit (0.1 ppm) of the HACH DR 900 Multiparameter Portable Colorimeter.

As shown in FIG. 2b, this observation is visually apparent from the colour difference between the feed and permeate solutions, where the feed solution shows a pink coloration, which is evidence for the presence of residual CI, while the permeate solution remains transparent, which is evidence for the absence (or at the very least, a negligibly low concentration) of CI.

Over the course of 24 h of filtration and regular analysis of the permeate solution (every 3-4 h), the level of Cl and/or chloramines in the permeate solution was observed to remain below the detection limit of the colorimeter (0.04 ppm). Moreover, the 4 ppm NH₂Cl solution was tested at various filtration pressures (1, 2, 2.8 and 3.6 bar). In each case, no residual NH₂Cl was detected in the permeate solution, and hence, the concentration was below the detection limit of the instrument.

### Membrane Thickness

The inventors observed that the thickness of the flat sheet GO membranes sometimes affects the rejection rate (%) and water flux (LMH/bar).

For instance, thick flat sheet GO membranes tend to have a higher rejection rate at the cost of the lower water flux. While thin flat sheet GO membranes allow a higher water flux while remaining a high rejection of 4-ppm chlorine solution.

To test for this, flat sheet GO membranes were prepared with different thicknesses using the system shown in FIG. 1a. The thickness of the GO membrane was varied by changing the amount of GO flakes in the feed solution (mass loading of GO).

The inventors performed long-term tests with flat sheet GO membranes of varying thickness to ascertain their long-term performance.

Thin flat sheet GO membranes (mass loading <0.06 mg/cm²) showed an increase in Cl concentration in the permeate side after around 30 h of continuous filtration.

In contrast, thick flat sheet GO membranes with mass loading >0.08 mg/cm² showed no detectable level of Cl in the permeate solution even after 6 days of continuous operation.

Since thin flat sheet GO membranes showed a higher water flux, it is worth investigating why these thin flat sheet GO membranes fail after around 30 h of filtration.

In the following, the sample flat sheet GO membranes are labelled according to the mass loading of GO flakes, for example, the flat sheet GO membrane produced with a mass loading of GO flakes of 0.04 mg/cm² is labelled GO_{0.04}.

To investigate why thin flat sheet GO membranes fail and thicker flat sheet GO membranes continue to function, a series of experiments were conducted in order to ascertain if chlorine (Cl) and/or chloramines from a chlorinated feed solution adsorb to sites within the flat sheet GO membranes.

If adsorption is responsible for this observed effect, then it is likely that the adsorption sites in the flat sheet GO membranes may become saturated over time, with the thinner flat sheet GO membranes becoming saturated quicker than the thicker flat sheet GO membranes.

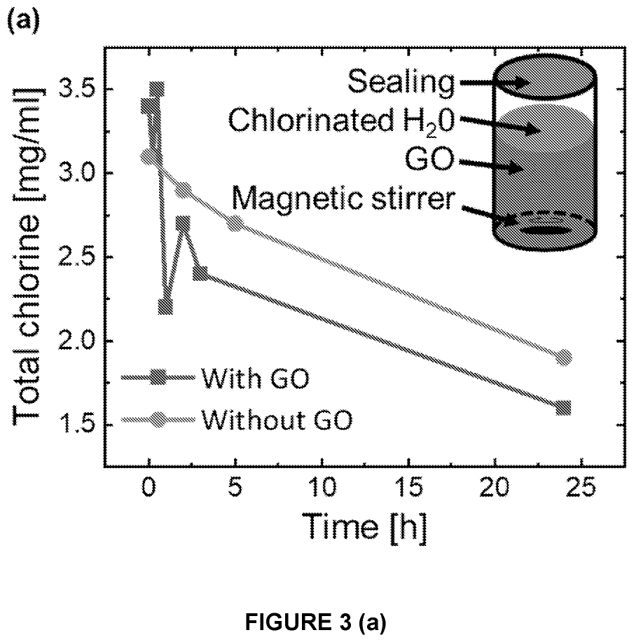

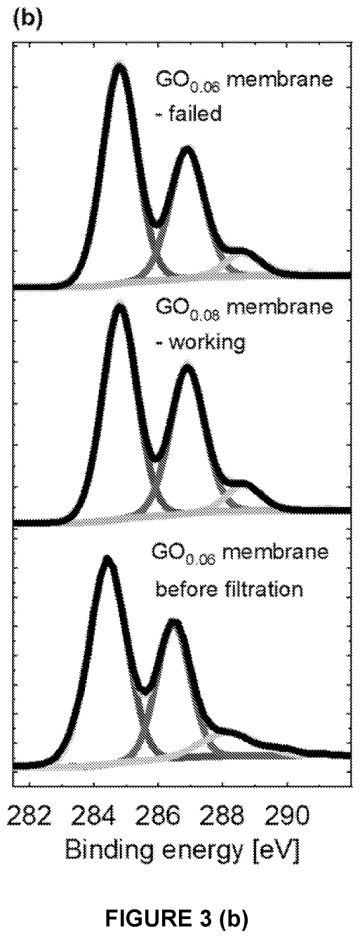

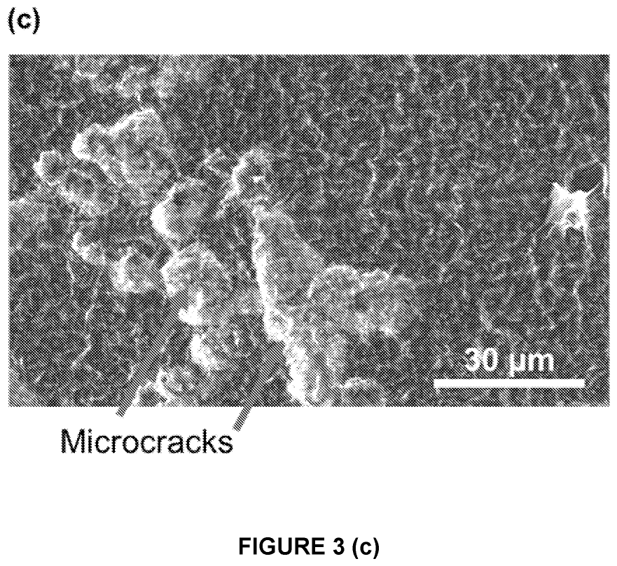

Specifically, as shown in FIG. 3a, a flat sheet GO membrane with a mass loading of 0.08 mg/cm² was placed inside a sealed vessel containing a chlorinated solution (around 3 ppm total chlorine), which was stirred with a magnetic stirrer for a period of 24 h.

For reference, a similarly prepared chlorinated solution was placed inside a second vessel without the presence of a flat sheet GO membrane, and the concentration of chlorine (Cl) in the two chlorinated solutions was monitored over the 24 h period, as described in the experimental section below.

For both solutions, the total chlorine concentration (mg/ml) was found to decrease over time due to decomposition of the residual Cl brought about by reactions with other contaminants present in solution, ultimately accelerated by the stirring process and light conditions, where the rate at which the Cl concentration declined was similar for both solutions, irrespective of whether a GO membrane is present in solution or not.

From this result, the inventors conclude that the complete removal of Cl from the chlorinated solution is not due to Cl being adsorbed to sites within the flat sheet GO membranes. Consequently, the failure of thin flat sheet GO membranes after prolonged filtration process must have a different reason then saturated adsorption sites.

To further investigate whether chemical changes in GO might be responsible for the failure of the thin flat sheet GO membranes, GO_{0.06} and GO_{0.06} were chemically analysed by XPS, before and after filtration.

FIG. 3b shows XPS spectra of the C1s peak of the respective flat sheet GO membrane samples. By fitting the peaks of the C1s structure, one can analyse the C—C (284.8 eV), C—O—C (286 eV) and C═O (288.5 eV) bonds that the carbon atoms in GO form with each other and the oxygen functional groups. No difference in the C1s peak before and after the filtration for the thick and thin flat sheet GO membranes was observed. Hence, the carbon atoms that form the GO network in each of these flat sheet GO membranes undergo no detectable changes.

Furthermore, the carbon/oxygen (C/O) ratio of the flat sheet GO membranes remains unchanged before and after filtration. This supports the fact that no chemical changes are induced due to the filtration process or exposure to chlorine (Cl). Moreover, only around 0.1 atomic percentage of Cl was detected by XPS, which suggests that any adsorption of Cl at the possible adsorption sites of the flat sheet GO membrane is unlikely. The combined results of chemical analysis and adsorption experiments leave no indication that the failure of the GO_{0.06} membrane after 30 h of filtration originates from chemical changes or saturation of adsorption sites within the flat sheet GO membranes. These observations further shine light on the filtration mechanisms as no observable chemical changes or adsorption of Cl is detectable, which suggests that other mechanisms are responsible for the removal of residual chlorine and/or chloramines from the liquid feed.

FIG. 3c shows an SEM image of the surface morphology of a GO_{0.06} sample after failing during prolonged filtration tests. The SEM image reveals microcracks on the surface of the membranes which were not visible before the filtration or in thicker GO membranes after prolonged use.

Without wishing to be bound by any one particular theory, the inventors attribute the failure of the thinner flat sheet GO membranes to effectively reject (filter) test species over prolonged periods due to the formation of microcracks caused by the prolonged exposure to external pressure during the filtration process.

In contrast, the thicker flat sheet GO membranes were found to be more durable at withstanding this pressure, as evidenced by their long-term stability during the filtration tests.

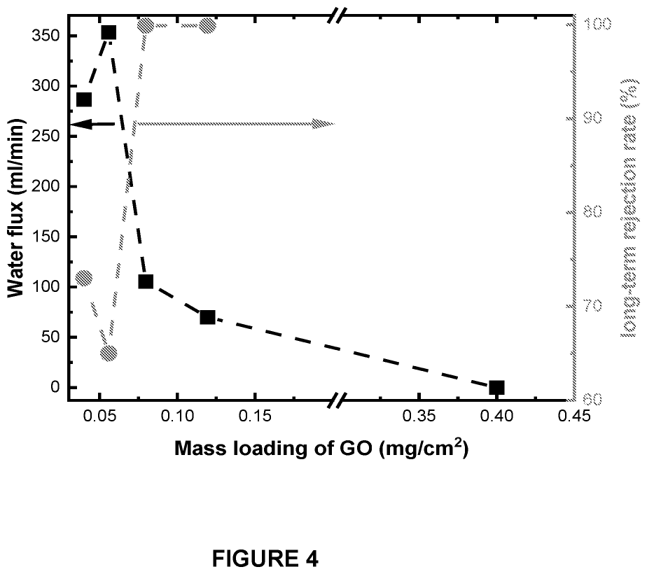

For instance, FIG. 4 illustrates that the prolonged use of a flat sheet GO membrane having a thickness of <0.06 mg/cm² (expressed as mass loading) over a period of 24 h leads to microcrack formations which compromise the rejection (filtration) of hypochlorite (ClO⁻).

On the other hand, mass loadings (of GO) of >0.4 mg/cm² lead to a decrease in water flux. Hence, the optimal operation thickness (mass loading) for long-term durable GO membranes is between 0.06 mg/cm² and 0.4 mg/cm².

In short, the results above indicate that there is an optimal thickness for flat sheet GO membranes that allows for long-term stability of >14 days of continuous operation, and an economic water flux.

### Hollow Fibre Membranes

### Fabrication

The experiments described above on flat sheet GO membranes confirm their effectiveness to at least partially remove residual chlorine and/or chloramines from aqueous solutions when the GO membranes are of an appropriate thickness, enabling them to function successfully over several days of operation.

In practical applications, however, it is often more desirable to use hollow fibre membranes (as opposed to flat sheet membranes) due to their better volume/surface area ratio.

In the following, the inventors tested GO coated hollow fibre membranes for their ability to remove residual chlorine and/or chloramines from tap water. The coating procedure and test conditions are as described in the experimental section.

Typically, the hollow fibres are porous and can be manufactured from a polymer selected from the group consisting of polyvinylidene fluoride (PVDF), cellulose acetate (CA), polysulfone (PS), polyamide, polyacrylonitrile (PAN) and polyether sulfone (PES), a ceramic selected from the group consisting of aluminium oxide (Al₂O₃), or any combination thereof.

In a preferred embodiment, the hollow fibres are polyvinylidene fluoride (PVDF) fibres having a length that falls within a range of between about 1 cm to about 5 m.

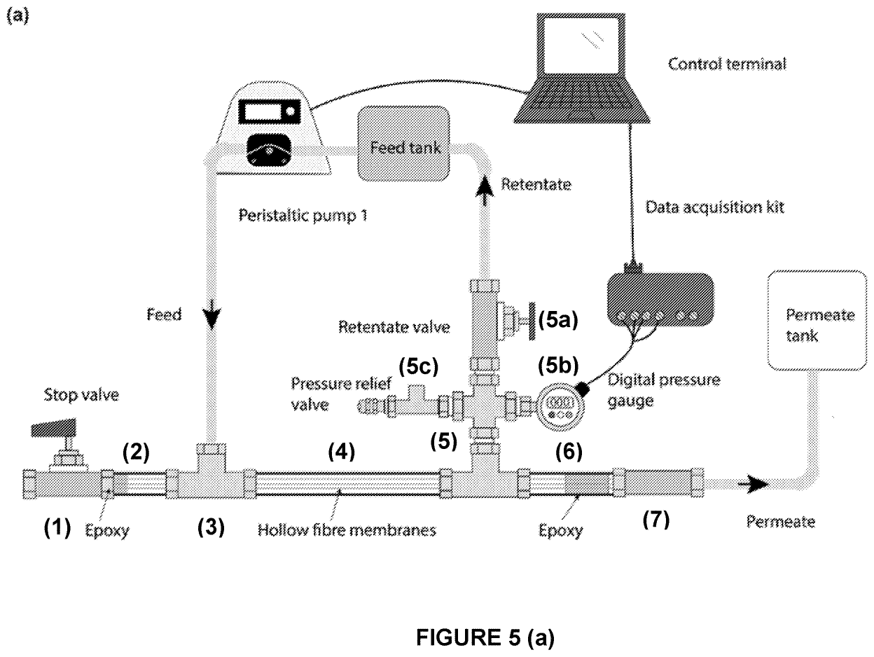

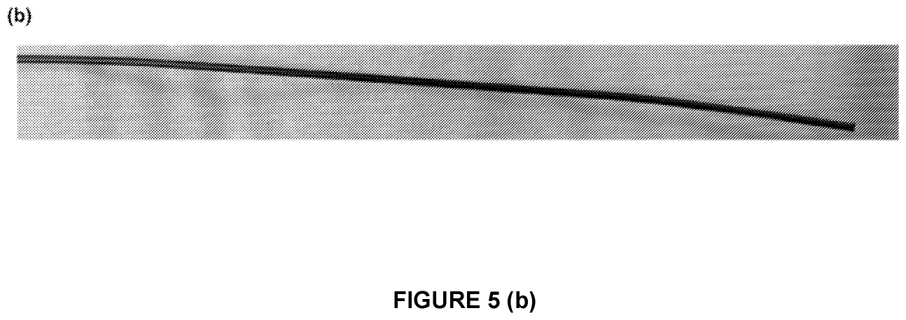

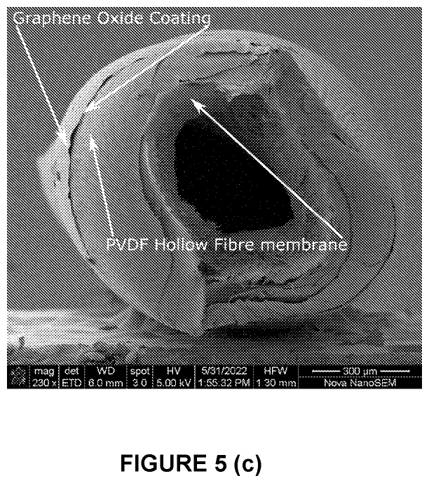

Specifically, as shown in FIG. 5a, commercially available PVDF hollow fibres are mounted at both ends within a steel tube (2) with epoxy glue. A solution comprising a dispersion of graphene oxide (GO) is then pumped from a feed tank using a peristaltic pump (1) through the T-piece (3) into the steel tube (2). There, the GO solution coats the surface(s) of the hollow PVDF fibres to form one or more layers of GO flakes with a mass loading that falls within a range of between about 0.01 mg/cm² to about 1 mg/cm², resulting in a thickness that falls within a range of between about 10 nm to about 10 μm, and an active area that falls within a range of between about 1 cm² to about 20 m².

Again, for removing residual chlorine and chloramine disinfectants from a particular feed (such as tap water, wastewater or a municipal water supply), the inventors have observed excellent results (as detailed below) in which the GO membrane comprises two or more layers of GO flakes formed as stacked sheets on the external surface of the PVDF hollow fibres, as shown in FIGS. 5b and 5c.

While only the external surface of the PVDF hollow fibre is shown in FIG. 5c to be coated with a GO membrane layer, it will be appreciated by persons skilled in the relevant art that it is also possible to coat the internal surface of a hollow fibre under certain conditions.

In the hollow fibre GO membranes shown in FIGS. 5b and 5c, the interlayer spacing between the stacked sheets of GO flakes, as determined by X-ray diffraction, was observed to fall within a range of between about 1.1 nm to about 1.4 nm, depending on the conditions employed, as specified below.

For instance, the inventors have observed that the interlayer spacing between stacked GO sheets of the hollow fibre GO membrane can be influenced during production by altering the pressure and/or temperature.

For example, in one embodiment, when the hollow fibre GO membrane is treated at a temperature that falls within a range of between about 25° C. to about 100° C., the interlayer spacing between the stacked sheets of GO flakes, as determined by X-ray diffraction, was observed to fall within a range of between about 0.8 nm to about 1.4 nm.

As will be discussed in more detail below, good results were obtained when the manufacturing process is conducted at 22° C. and 1 bar to obtain a PVDF hollow fibre membrane comprising a GO coating on at least the external surface of each hollow fibre to a thickness of 500 nm, corresponding to a mass loading of GO flakes of 0.06 mg/cm², in which the GO coating consists of stacked GO sheets having an interlayer spacing of 1.4 nm.

### Testing

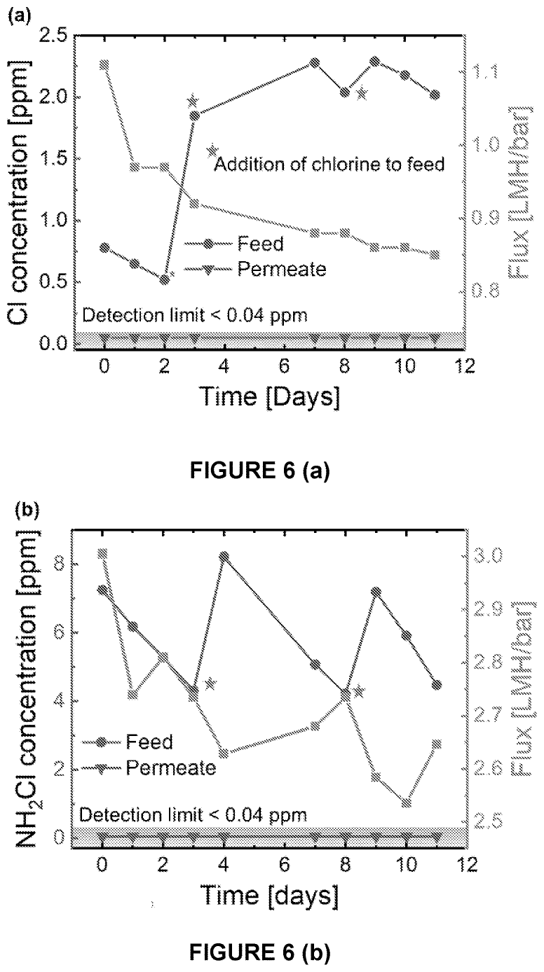

FIG. 6 shows the result of a long-term test for the removal of (a) residual chlorine (Cl) and (b) monochloramine (NH₂Cl) from tap water-based solutions using hollow fibre GO membranes. Over the course of the experiment, the level of residual chlorine (Cl) or NH₂Cl in the feed side was adjusted by adding additional solution, where appropriate (as indicated by an asterisk) so that, the feed chlorine concentration could be maintained at a realistic level for tap water.

Over a period of 11 days of continuous operation, no residual Cl or NH₂Cl could be detected on the permeate side (below a detection limit of <0.04 ppm). Moreover, the water flux (L m⁻² h⁻¹ bar⁻¹ (LMH/bar) remained relatively constant over the course of operation.

However, a decrease in the water flux from initially 1.1 LMH/bar to ~0.85 LMH/bar was observed when monitoring the feed/permeate Cl levels (FIG. 6a), and from 3 LMH/bar to 2.6 LMH/bar when monitoring the feed/permeate NH₂Cl levels (FIG. 6b) after 11 days. This may be due to the compression of the macrostructure of the hollow fibre GO membrane, as typically observed during dead-end cell measurements or due to mild fouling of the hollow fibre GO membrane.

Without wishing to be bound by any one particular theory, the inventors believe that this observed variation in water flux for different hollow fibre GO membranes might result from slightly different coating thicknesses.

### Conclusions

Table 2 lists a number of species that were tested during the course of this work on both hollow fibre and flat sheet GO membranes. The results obtained clearly demonstrate that ions such as Mg²⁺ and Ca²⁺ are able to pass straight through the GO membrane into the permeate due to their hydrated radil being smaller than the molecular cut-off (~4.6-4.7 Å) associated with the pores, channels or interlayer spacings formed between the stacked GO sheets coated on the surface(s) of the hollow fibre or flat sheet GO membranes.

TABLE 2

| | Estimated | | |
|---|---|---|---|
| | hydrated | Expected to be | Rejection |
| Species | radius (Å) | rejected? | rate (%) |
| Mg²⁺ | 4.3 | No | ~20% |
| ClO⁻ | 3.5 | No | >99% |
| NH₂Cl | 4.5 | No | >99% |
| Ca²⁺ | 4.1 | No | ~20% |

Yet, surprisingly however, the inventors found that hypochlorite (ClO⁻) and monochloramine (NH₂Cl) are both rejected (filtered) by GO membranes with a rejection rate of >99%. This is completely unexpected as the hydrated radii for ClO⁻ (~3.5 Å) and NH₂Cl (4.5 Å) are below the molecular cut-off (~4.6-4.7 Å) associated with untreated GO membranes. Given this, a skilled person in the relevant would clearly expect that neither ClO— nor NH₂Cl would be rejected by an untreated GO membrane.

This study therefore shows that flat sheet and hollow fibre graphene oxide (GO) membranes can effectively be used to remove residual chlorine and/or chloramines from a water supply to levels of 0.04 ppm or less. The chemical analysis disclosed above suggests that under optimal conditions, both GO membrane types are chemically stable in a chlorine environment and undergo no detectable chemical changes over the course of several days of continuous operation, where the performance of the GO membrane is observed to be constant over a period of 11 days.

This study further shows that the filtration operation of the hollow fibre GO membranes is stable over the course of 11 days.

By showing that hollow fibre GO membranes are highly efficient and stable in removing residual chlorine and/or chloramines from tap water, the foundation is laid for an effective, scalable membrane that might substantially facilitate the use of tap water applications sensitive towards chlorine and/or chloramines.

### Experimental Section

### Preparation and Filtration Using Flat Sheet Membranes

GO solution synthesized via Hummer's method was supplied by Nishina Materials Japan. To manufacture the GO membrane, the GO solution is filtered through a polyvinylidene fluoride (PVDF) membrane with a 0.22 μm pore size in a dead-end filtration cell (see FIG. 1a).

The amount of solution controls the thickness of the resultant flat sheet GO membrane and is expressed herein as mass loading. The solution is pressed with 2 bar air pressure through the PVDF membrane. While the water passes through the pores, the GO flakes in the solution form a uniform layer of stacked sheets on the surface of the PVDF membrane. The active area of the flat sheet GO membranes is approximately 15 cm². After drying the as-produced flat sheet GO membrane for around 24 h under 2 bar pressure (FIG. 1b), the GO membrane is then tested for its ability to reject (filter) a test species in solution, by introducing a feed solution into the dead-end cell (FIG. 1c). With 1 bar pressure, the feed solution is pressed through the flat sheet GO membrane (FIG. 1d). The permeate is collected in a sealed glass beaker. After filtration, the permeate solution is then analysed using a HACH DR900 Multiparameter Portable Colorimeter (detection limit: 0.04 ppm) to determine the concentration of test species (if any) remains in solution. During the filtration, the water flux (L m⁻² h⁻¹ bar⁻¹ (LMH/bar)) is recorded using a set of scales electronically connected to a personal computer (PC).

### Preparation and Filtration Using Hollow Fibre Membranes

FIG. 5a shows a schematic representation of a system configured to coat commercial hollow fibre PVDF membranes with GO flakes. In the same setup, tests to remove any residual chlorine and/or chloramines were performed.

As shown in FIG. 5a, the system comprises a peristaltic pump, connected to a feed tank, which is configured to pump a feed solution from the feed tank into the system, in the direction as indicated by the arrows.

As also shown in FIG. 5a, the main part of the system comprises a straight hollow elongate tube that is configured to mount a hollow fibre membrane lengthwise substantially therein.

Specifically, the elongate tube is divided into 7 sections: (1) a stop valve is located at a first end of the straight tube and is configured to facilitate sealing of the elongate tube in use, (2) a short (5 cm length) hollow tube is mounted at a first end to the stop valve (1), and is configured internally to allow one end of a hollow fibre membrane to be attached substantially within the short tube (2) using a mounting means such as an adhesive material (epoxy glue). (3) A T-piece tubing is mounted at a first end to the opposing end of the short tube (2) and at a second end to a first end of (4) an elongate hollow tube (20 cm length) configured to substantially receive a large portion of the hollow fibre membrane therewithin in use. A third end of the T-piece tube (3) is operably connected to the peristaltic pump to allow the feed solution to be fluidly communicated by the pump from the feed tank to the hollow elongate tube. (5) A second T-piece is mounted at a first end to an opposing end of the elongate hollow tube (4) and at an opposing end to a first end of another (6) short (5 cm) hollow tube. The short tube (6) is configured to receive and attach the opposing end of the hollow fibre membrane substantially within the short tube (6) using a mounting means such as an adhesive material (epoxy glue). A third end of the T-piece (5) is fluidly coupled to (5a) a retentate valve that allows the feed solution having been fed through the hollow elongate tube to flow back to the feed tank for re-circulation around the system. The flow of this retentate fluid is monitored and computer-controlled by virtue of (5b) a digital pressure gauge operably connected to a personal computer (or control terminal) and (5c) a pressure relieve valve operably coupled substantially between the T-piece (5) and the retentate valve (5a). The opposing end part of the hollow elongate tube is left open to allow permeate solution to exit the hollow elongate tube via (7) a valve, which is to open or close to allow the permeate solution to flow to a permeate tank for collection.

The pressure inside the system is controlled via proportional-regulation of the pump speed and pressure gauge using a custom-made LabVIEW program. For that, the actual pressure Pᵣ of the pressure gauge is recorded and uploaded to the program. The program then calculates the difference between Pᵣ and the desired pressure Pa and translates the difference in pressure to a pump speed value S with an adjustable proportional value K with the following relation:

$$S = K * ( {P}_{r} - {P}_{d} ) \qquad ( 2 )$$

The water flux is measured by recording the amount of water on the permeate side over time. The concentration of any residual chlorine and/or chloramines in the permeate tank was recorded using a HACH SL1000 9 Portable Parallel Analyser with a detection limit of 0.04 ppm.

### Preparation and Characterization of Feed and Permeate Solution

Feed solution with desired chlorine concentration was prepared by adding sodium hypochlorite solution into either deionized (DI) water or tap water from Sydney water supply. Monochloramine solution for filtration tests using flat sheet membranes was prepared as follows: DI water-based solutions are prepared by mixing ammonia and hypochlorite solutions in the ratio of 1:6. Tap water used in this study was supplied by Sydney City water supply and the amount of ammonia and hypochlorite (ClO⁻) was adjusted to achieve the concentrations of hypochlorite (ClO⁻) and monochloramine (NH₂Cl) shown in Table 1.

Monochloramine solution for filtration tests using hollow fibre membranes was prepared following the procedure in NSF/ANSI 42. Sodium hypochlorite solution (14 wt. %) is diluted ten times with DI water. The diluted solution (0.45 mL, 1.4 wt. %) is then mixed with NH₄Cl powder (6 mg) and diluted into 1 L by DI water. The mixture is standing for 1 hour before using for filtration test.

The pH of the mixture is 8.5 after 1 hour of preparation. Given that the nature of the chloramine family is highly dependent on pH, it will be appreciated that the major chloramine species in solution at a pH 8.5 is monochloramine (NH₂Cl).

The feed solution was tested for total chlorine and monochloramine concentration immediately before insertion into the dead-end cell and every time the permeate side was tested in the case of the hollow fibre set-up. The total chlorine and monochloramine levels were detected with a HACH DR900 Multiparameter Portable Colorimeter and SL1000 (detection limit 0.04 ppm) and the respective reagents. Chlorine levels were evaluated by testing as total chlorine. The determination of all concentrations of any residual chlorine and/or chloramines was performed within 5 min (plus reagent times) after sampling the solution. In the commercial version of SL1000, it is required to have 100 ml of solution to test for chlorine or chloramine concentrations.

A custom-made testing cell was designed (not shown) so that the required volume could be lowered to 3 ml to allow frequent testing of the permeate solutions. The shape of the cell was specifically designed to support the HACH SL1000 Portable Parallel Analyser in the upright position to ensure good contact between the instrument and the solution over the period the instrument needs to determine the concentration.

### Experimental Procedures for Long-Term Tests

The long-term performance of the membranes is evaluated for flat sheet and hollow fibre membranes.

For the flat sheet membranes, the procedure was as follows:

After membrane fabrication, 200 ml of feed solution is added into the dead-end cell. The filtration process is started by applying 1 bar pressure to the feed side. The first 5 ml of permeate is chemically analysed for the concentration of any residual chlorine and/or chloramines. If the concentration of any residual chlorine and/or chloramines in the permeate is below detection limit (<0.04 ppm), the membrane is regarded as functional. In case the membranes would fail, the level of residual chlorine and/or chloramines in the permeate side would increase. Hence, an increase in the concentration of chlorine and/or chloramines in the permeate side is a good indicator of the functionality of the membrane. As long as the concentration of the residual chlorine and/or chloramines in the permeate is below the detection limit, it is thus regarded as functional. If any residual chlorine and/or chloramines is detectable in the permeate side, the membrane is regarded as damaged. The time span the permeate solution was produced with concentrations of any residual chlorine and/or chloramines below the detection limit can be regarded as the lifetime of the membrane.

To test this, the filtration is continuously run and the level of any residual chlorine and/or chloramines in the permeate side is regularly checked. After each check, the permeate side vessel is emptied to avoid dilution of the permeate. If the permeate side of the dead-end cell reaches a volume of 150 ml, it means that the feed side has only 50 ml left in the dead-end cell. Hence, the dead-end cell is opened, and the feed side is replaced with freshly prepared and chemically analysed feed solution. Then the filtration process is continued by applying pressure to the feed side.

The long-term performance of the hollow fibre set-up was tested as follows:

The feed solution is introduced into the system via the feed tube and peristaltic pump. The filtration process is continuously run while the computer automation ensures a constant pressure of 1±0.1 bar. The permeate side is collected in the sealed permeate container. For each datapoint shown in the results, the permeate and feed sides were chemically analysed at the same time and within 5 min of sampling. The level of any residual chlorine and/or chloramines in the feed solution may vary over time.

Hence, by adding additional chlorine or by regularly replacing the monochloramine feed solution, it was ensured that the chlorine level in the feed side stays within the tested ranges. As it is important to test the membrane under realistic concentrations, the following concentration ranges (0.5-1 ppm, 1-2 ppm, 4-6 ppm and 8-10 ppm) were chosen as these are representative of typical tap water. As in the case of flat sheet membranes, the membrane was considered intact for as long as the permeate concentration of any residual chlorine and/or chloramines was <0.04 ppm. If the concentration of any residual chlorine and/or chloramines in the permeate side is higher, the membrane is considered a failure.

### Determination of Water Flux

Water flux of GO membranes was calculated based on the following equation (3):

$${J}_{w} = \frac{Q}{AP Δ t} \qquad ( 3 )$$

Where, J_{w} stands for water flux (L·m⁻²·h⁻¹·bar⁻¹ (or) LMH/bar), Q is the volume of permeate, A represents the effective area of the GO membrane, P is the applied pressure during filtration, and Δt stands for the filtration duration.

### Chemical and Structural Analysis of the Membranes

The prepared membranes were chemically and structurally characterized by various analytical techniques. Scanning electron microscopy (SEM, FEI Nova NanoSEM 230, FE-SEM) was employed to visualize the surface morphology. The chemical compositions of the GO membranes were investigated by X-ray photoelectron spectroscopy (XPS, Thermo Scientific UK, ESCALAB250Xi) using monochromatic Al K alpha (energy 1486.68 eV) X-ray source. Details of the chemical and structural analysis are outlined in the Detailed Description above.

### EMBODIMENTS

Reference throughout this specification to “one embodiment” or “an embodiment” means that a particular feature, structure or characteristic described in connection with the embodiment is included in at least one embodiment of the present invention. Thus, appearances of the phrases “in one embodiment” or “in an embodiment” in various places throughout this specification are not necessarily all referring to the same embodiment but may. Furthermore, the particular features, structures or characteristics may be combined in any suitable manner, as would be apparent to one of ordinary skill in the art from this disclosure, in one or more embodiments.

Similarly, it should be appreciated that in the above description of example embodiments of the invention, various features of the invention are sometimes grouped together in a single embodiment, figure, or description thereof for the purpose of streamlining the disclosure and aiding in the understanding of one or more of the various inventive aspects. This method of disclosure, however, is not to be interpreted as reflecting an intention that the claimed invention requires more features than are expressly recited in each claim. Rather, as the following claims reflect, inventive aspects lie in less than all features of a single foregoing disclosed embodiment. Thus, the claims following the Detailed Description of Specific Embodiments are hereby expressly incorporated into this Detailed Description of Specific Embodiments, with each claim standing on its own as a separate embodiment of this invention.

Furthermore, while some embodiments described herein include some, but not other features included in other embodiments, combinations of features of different embodiments are meant to be within the scope of the invention, and form different embodiments, as would be understood by those in the art. For example, in the following claims, any of the claimed embodiments can be used in any combination.

### Different Instances of Objects

As used herein, unless otherwise specified the use of the ordinal adjectives “first”, “second”, “third”, etc., to describe a common object, merely indicate that different instances of like objects are being referred to, and are not intended to imply that the objects so described must be in a given sequence, either temporally, spatially, in ranking, or in any other manner.

### Specific Details

In the description provided herein, numerous specific details are set forth. However, it is understood that embodiments of the invention may be practiced without these specific details. In other instances, well-known methods, structures and techniques have not been shown in detail in order not to obscure an understanding of this description.

### Terminology

In describing the preferred embodiment of the invention illustrated in the drawings, specific terminology will be resorted to for the sake of clarity. However, the invention is not intended to be limited to the specific terms so selected, and it is to be understood that each specific term includes all technical equivalents which operate in a similar manner to accomplish a similar technical purpose. Terms such as “forward”, “rearward”, “radially”, “peripherally”, “upwardly”, “downwardly”, and the like are used as words of convenience to provide reference points and are not to be construed as limiting terms.

### Definitions

As used throughout, the singular forms “a,” “an,” and the include plural referents unless the context clearly dictates otherwise.

Ranges can be expressed herein as from “about” one particular value, and/or to “about” another particular value. When such a range is expressed, another aspect includes from the one particular value and/or to the other particular value. Similarly, when values are expressed as approximations, by use of the antecedent “about,” it will be understood that the particular value forms another aspect. It will be further understood that the endpoints of each of the ranges are significant both in relation to the other endpoint, and independently of the other endpoint.

### Comprising and Including

In the claims which follow and in the preceding description of the invention, except where the context requires otherwise due to express language or necessary implication, the word “comprise” or variations such as “comprises” or “comprising” are used in an inclusive sense, i.e. to specify the presence of the stated features but not to preclude the presence or addition of further features in various embodiments of the invention.

Any one of the terms: including or which includes or that includes as used herein is also an open term that also means including at least the elements/features that follow the term, but not excluding others. Thus, including is synonymous with and means comprising.

### Scope of Invention

Thus, while there has been described what are believed to be the preferred embodiments of the invention, those skilled in the art will recognize that other and further modifications may be made thereto without departing from the spirit of the invention, and it is intended to claim all such changes and modifications as fall within the scope of the invention. For example, any formulas given above are merely representative of procedures that may be used. Steps may be added or deleted to methods described within the scope of the present invention.

Although the invention has been described with reference to specific examples, it will be appreciated by those skilled in the art that the invention may be embodied in many other forms.

### INDUSTRIAL APPLICABILITY

It is apparent from the above, that the arrangements described are applicable to the water purification industry.

1: Use of a graphene oxide membrane for removing at least a portion of one or more disinfectants from a liquid feed, wherein the disinfectants are solutes selected from the group consisting of chlorine and/or a chloramine.

2: The use according to claim 1, wherein the graphene oxide membrane comprises one or more layers of graphene oxide flakes supported on at least one surface of a substrate.

3: The use according to claim 1, wherein the graphene oxide membrane comprises two or more layers of graphene oxide flakes supported on at least one surface of the substrate, wherein an interlayer spacing between the two or more layers of graphene oxide flakes falls within a range of between about 0.4 nm to about 5 nm.

4: The use according to claim 1, wherein the substrate is a porous membrane.

5: The use according to claim 4, wherein the two or more layers of graphene oxide flakes supported on the at least one surface of the porous membrane defines an active area that falls within a range of between about 1 cm² to about 40 m².

6: The use according to claim 4, wherein the two or more layers of graphene oxide flakes supported on the at least one surface of the porous membrane has a thickness that falls within a range of between about 10 nm to about 10 μm.

7: The use according to claim 4, wherein the graphene oxide membrane has a mass loading of graphene oxide flakes on the at least one surface of the porous membrane that falls within a range of between about 0.01 mg/cm² to about 1 mg/cm².

8: The use according to claim 1, wherein the substrate comprises one or more hollow fibres.

9: The use according to claim 8, wherein the one or more hollow fibres are porous.

10: The use according to claim 8, wherein each hollow fibre has a length that falls within a range of between about 1 cm to about 5 m.

11: The use according to claim 8, wherein the one or more layers of graphene oxide flakes supported on at least one surface of the or each hollow fibre have a thickness that falls within a range of between about 10 nm to about 10 μm.

12: The use according to claim 8, wherein the one or more layers of graphene oxide flakes supported on the at least one surface of the or each hollow fibre define an active area that falls within a range of between about 1 cm² to about 20 m².

13: The use according to claim 8, wherein the graphene oxide membrane has a mass loading of graphene oxide flakes on the at least one surface of the or each hollow fibre that falls within a range of between about 0.01 mg/cm² to about 1 mg/cm².

14: The use according to claim 1, wherein the GO membrane is treated at a temperature that falls within a range of between about 25° C. to about 100° C.

15: The use according to claim 1, wherein the GO membrane is treated at a pressure that falls within a range of between about 0.1 bar to about 10 bar.

16: The use according to claim 1, wherein the substrate is manufactured from a polymer selected from the group consisting of polyvinylidene fluoride (PVDF), cellulose acetate (CA), polysulfone (PS), polyamide, polyacrylonitrile (PAN) and polyether sulfone (PES), a ceramic selected from the group consisting of aluminium oxide (Al2O3), or any combination thereof.

17: The use according to claim 1, wherein the liquid feed is an aqueous medium selected from the group consisting of tap water, wastewater, and municipal water supply.

18: The use according to claim 1, wherein the chloramine is selected from the group consisting of monochloramine (NH₂Cl), dichloramine (NHCl₂), trichloramine (NCl₃), or any combination thereof.

19: A method of removing at least a portion of one or more disinfectants from a liquid feed, comprising:
passing a liquid feed comprising one or more disinfectants over and/or through a graphene oxide membrane, thereby removing at least a portion of the one or more disinfectants from the liquid feed,
wherein the disinfectants are solutes selected from the group consisting of chlorine and/or a chloramine.

20: A method according to claim 19, wherein the chloramine is selected from the group consisting of monochloramine (NH2Cl), dichloramine (NHCl2), trichloramine (NCl3), or any combination thereof.

21-29. (canceled)
